(19) United States
(12) Patent Application Publication
(10) Pub. No.: US 2017/0015252 A1
(43) Pub. Date: Jan. 19, 2017

(54) Storage System

(71) Applicants: Alberta Tchetgen, Herndon, VA (US); Stella D. Tchetgen, Herndon, VA (US); MB Tchetgen, Herndon, VA (US)

(72) Inventors: Alberta Tchetgen, Herndon, VA (US); Stella D. Tchetgen, Herndon, VA (US); MB Tchetgen, Herndon, VA (US)

(21) Appl. No.: 14/801,903

(22) Filed: Jul. 17, 2015

(51) Int. Cl. B60R 7/04; B60N 2/01; B60N 2/48

(52) U.S. Cl. CPC B60R 7/043; B60N 2/48; B60N 2/01

(57) ABSTRACT

A storage system for storing items in a vehicle includes a vehicle has a pair of seats. A container is provided that may store items. The container is removably attached between the seats such that the container may be accessible from an interior of the vehicle. A fastener is removably coupled to the container. The fastener engages the seats such that the container is retained between the seats.

### BACKGROUND OF THE DISCLOSURE

### Field of the Disclosure

The disclosure relates to storage devices and more particularly pertains to a new storage device for storing items in a vehicle.

### SUMMARY OF THE DISCLOSURE

An embodiment of the disclosure meets the needs presented above by generally comprising a vehicle has a pair of seats. A container is provided that may store items. The container is removably attached between the seats such that the container may be accessible from an interior of the vehicle. A fastener is removably coupled to the container. The fastener engages the seats such that the container is retained between the seats.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The items of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and items other than those set forth above will become apparent when consideration is given to the following detailed description thereof. Such description makes reference to the annexed drawings wherein:

FIG. 1 is a perspective view of a storage system according to an embodiment of the disclosure.

FIG. 2 is an exploded perspective view of an embodiment of the disclosure.

FIG. 3 is a back view of an embodiment of the disclosure.

FIG. 4 is a perspective in-use view of an embodiment of the disclosure.

### DESCRIPTION OF THE PREFERRED EMBODIMENT

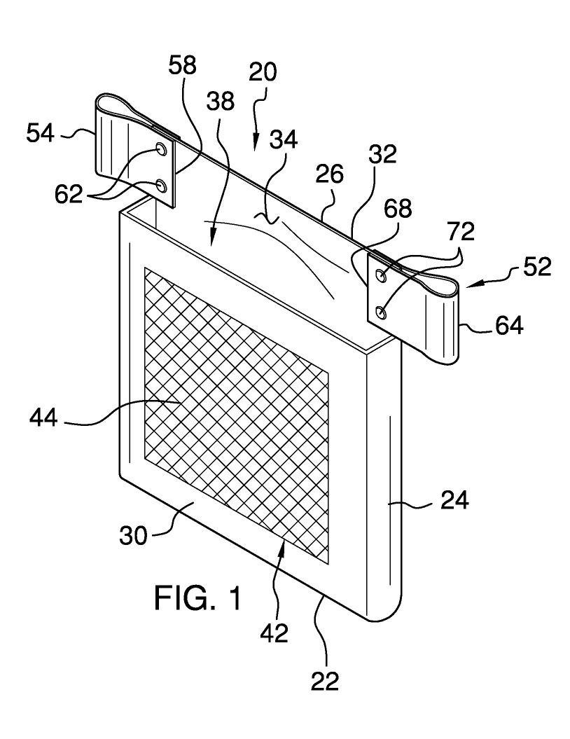

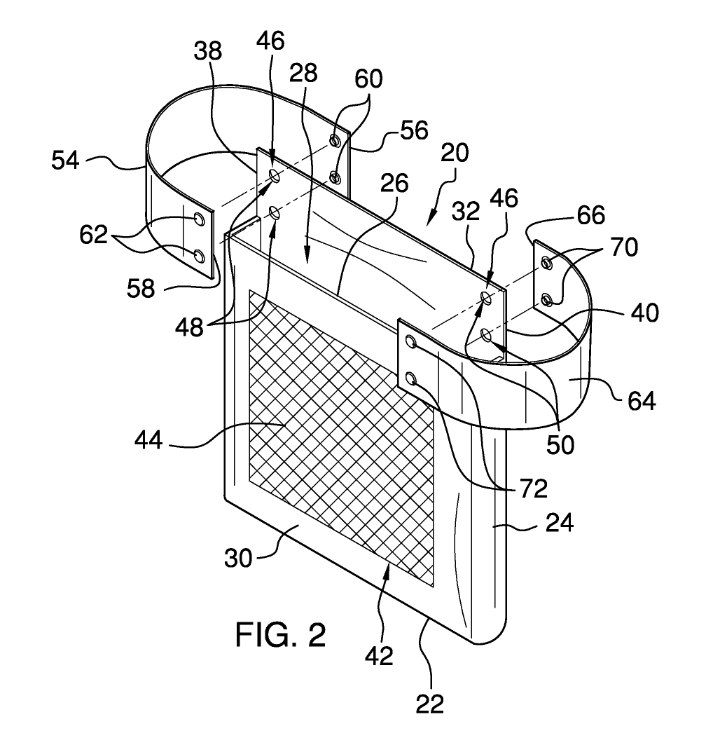

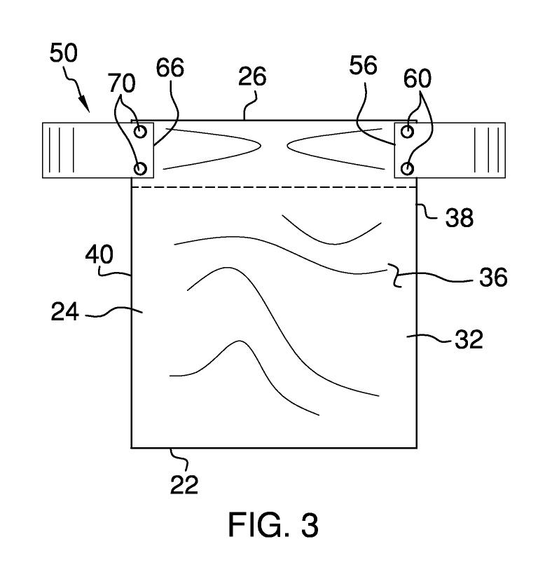

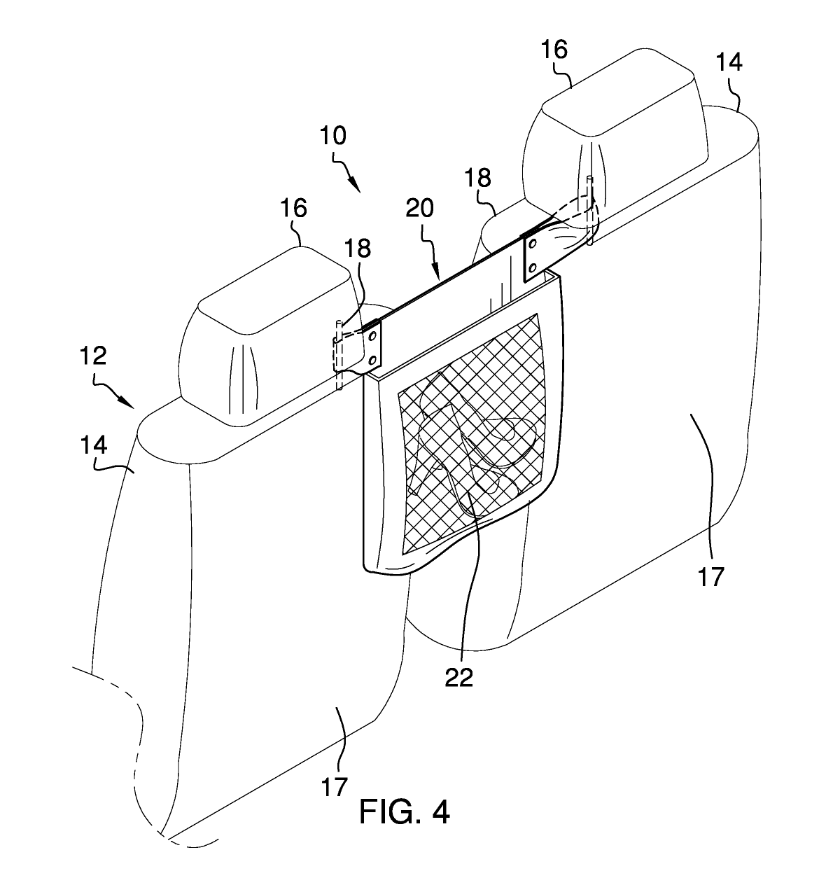

With reference now to the drawings, and in particular to FIGS. 1 through 4 thereof, a new storage device embodying the principles and concepts of an embodiment of the disclosure and generally designated by the reference numeral 10 will be described.

As best illustrated in FIGS. 1 through 4, the storage system 10 generally comprises a vehicle 12 that has a pair of seats 14. The seats 14 are spaced from each other and each of the seats 14 has a head rest 16 and a rear side 17. The head rest 16 on each of the seats 14 has a support 18 and the vehicle 12 may be a passenger vehicle or the like. A container 20 is provided that may store items 22. The container 20 is removably attached between the seats 14 such that the container 20 is accessible from an interior of the vehicle 12.

The container 20 has a bottom wall 22 and a peripheral wall 24 extending upwardly from the bottom wall 22. The peripheral wall 24 has a distal edge 26 with respect to the bottom wall 22 such that the distal edge 26 defines an opening 28 into the container 20. The peripheral wall 24 has a front side 30 and a back side 32. The back side 32 has a height that is greater than the front side 30 such that the back side 32 extends upwardly from the opening 28. The back side 32 has a front surface 34, a back surface 36, a first lateral edge 38 and a second lateral edge 40. The front side 30 of the container 20 has an opening 42 extending therethrough. A mesh 44 is coupled to the container 20. The mesh 44 is positioned on the front side 30 such that the mesh 44 covers the opening 42 in the front side 30. Thus, the mesh 44 retains the items 22 within the container 20.

The back side 32 has a plurality of apertures 46 extending therethrough and the plurality of apertures 46 includes a first set 48 of the apertures 46 and a second set 50 of the apertures 46. The first set of apertures 48 is positioned adjacent to the first lateral edge 38 and the first set of apertures 48 is spaced from the distal edge 26 corresponding to the back side 32. The second set of apertures 50 is positioned adjacent to the second lateral edge 40 and the second set of apertures 50 is spaced from the distal edge 26 corresponding to the back side 32.

A fastener 52 is removably coupled to the container 20. The fastener 52 engages the seats 14 such that the container 20 is retained between the seats 14. The fastener 52 comprises a first strap 54 that has a first end 56 and a second end 58. A pair of first couplers 60 is provided and each of the first couplers 60 is attached to the first strap 54. Each of the first couplers 60 is positioned adjacent to the first end 56. A pair of second couplers 62 is provided and each of the second couplers 62 is attached to the first strap 54. Each of the second couplers 62 is positioned adjacent to the second end 58. Each of the first couplers 60 and the second couplers 62 may comprise complementary halves of a snap or the like.

A second strap 64 is provided that has a first end 66 and a second end 68. A pair of primary couplers 70 is provided and each of the primary couplers 70 is attached to the second strap 64. Each of the primary couplers 70 is positioned adjacent to the first end 66 of the second strap 64. A pair of secondary couplers 72 is provided and each of the secondary couplers 72 is attached to the second strap 64. Each of the secondary couplers 72 is positioned adjacent to the second end 68 of the second strap 64 and each of the primary 70 and secondary 72 couplers may comprise complementary halves of a snap or the like

In use, the first strap 54 is wrapped around the support 18 on an associated one of the seats 14. Each of the first couplers 60 is extended through the associated ones of the first set of apertures 48 to engage the second couplers 62 such that the first strap 54 removably couples the container 20 to the associated seat 14. The secondary strap 64 is wrapped around the support 18 on an associated one of the seats 14. Each of the primary couplers 70 is extended through associated ones of the second set of apertures 50 to engage the secondary couplers 72 such that the second strap 64 removably couples the container 20 to the associated seat 14. The container 20 is positioned proximate the rear side 17 of each of the pair of seats 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A storage system comprising:
a vehicle having a pair of seats, wherein said seats are spaced from each other, each of said seats having a head rest, said head rest on each of said seats having a vertical support;
a container being configured to store items, said container being removably attached between said seats such that said container is configured to be accessible from an interior of said vehicle, wherein said container has a bottom wall and a peripheral wall extending upwardly from said bottom wall, said peripheral wall having a distal edge with respect to said bottom wall such that said distal edge defines an opening into said container, said peripheral wall having a front side and a back side, said back side having a height being greater than said front side such that said back side extends upwardly from said opening; and
a fastener being removably coupled to said container, said fastener engaging said seats wherein said container is retained directly between said seats,
wherein said fastener comprises
a first strap having a first end and a second end,
a pair of first couplers, each of said first couplers being attached to said first strap, each of said first couplers being positioned adjacent to said first end,
a pair of second couplers, each of said second couplers being attached to said first strap, each of said second couplers being positioned adjacent to said second end, and
wherein said first strap is wrapped around said support on an associated one of said seats, each of said first couplers engaging said front surface of said back side adjacent to said first lateral edge of said back side, each of said second couplers engaging said back surface of said back side adjacent to said first lateral edge such that said first strap removably couples said container to said associated seat.

2. (canceled)

3. The system according to claim 1, wherein said back side having a front surface, a back surface, a first lateral edge and a second lateral edge, said front side having an opening extending therethrough.

4. The system according to claim 3, further comprising a mesh being coupled to said container, said mesh being positioned on said front side such that said mesh is configured to retain the items within said container.

5. (canceled)

6. The system according to claim 1, wherein said fastener further comprises:
a pair of first couplers, each of said first couplers being attached to said first strap, each of said first couplers being positioned adjacent to said first end; and
a pair of second couplers, each of said second couplers being attached to said first strap, each of said second couplers being positioned adjacent to said second end.

7. (canceled)

8. The system according to claim 1, wherein said fastener further comprises:
a second strap having a first end and a second end; and
a pair of primary couplers, each of said primary couplers being attached to said second strap, each of said primary couplers being positioned adjacent to said first end of said second strap.

9. The system according to claim 8, wherein said fastener further comprises a pair of secondary couplers, each of said secondary couplers being attached to said second strap, each of said secondary couplers being positioned adjacent to said second end of said second strap.

10. The system according to claim 9, wherein said secondary strap is wrapped around said support on an associated one of said seats, each of said primary couplers engaging said front surface of said back side adjacent to said second lateral edge of said back side, each of said secondary couplers engaging said back surface of said back side adjacent to said second lateral edge such that said second strap removably couples said container to said associated seat.

11. A storage system comprising:
a vehicle having a pair of seats, said seats being spaced from each other, each of said seats having a head rest, said head rest on each of said seats having a support;
a container being configured to store items, said container being removably attached between said seats such that said container is configured to be accessible from an interior of said vehicle, said container having a bottom wall and a peripheral wall extending upwardly from said bottom wall, said peripheral wall having a distal edge with respect to said bottom wall such that said distal edge defines an opening into said container, said peripheral wall having a front side and a back side, said back side having a height being greater than said front side such that said back side extends upwardly from said opening, said back side having a front surface, a back surface, a first lateral edge and a second lateral edge, said front side having an opening extending therethrough;
a mesh being coupled to said container, said mesh being positioned on said front side such that said mesh covers said opening wherein said mesh is configured to retain the items within said container; and
a fastener being removably coupled to said container, said fastener engaging said seats wherein said container is retained directly between said seats, said fastener comprising:
a first strap having a first end and a second end,
a pair of first couplers, each of said first couplers being attached to said first strap, each of said first couplers being positioned adjacent to said first end,
a pair of second couplers, each of said second couplers being attached to said first strap, each of said second couplers being positioned adjacent to said second end, said first strap being wrapped around said support on an associated one of said seats, each of said first couplers engaging said front surface of said back side adjacent to said first lateral edge of said back side, each of said second couplers engaging said back surface of said back side adjacent to said first lateral edge such that said first strap removably couples said container to said associated seat,
a second strap having a first end and a second end,
a pair of primary couplers, each of said primary couplers being attached to said second strap, each of said primary couplers being positioned adjacent to said first end of said second strap, and
a pair of secondary couplers, each of said secondary couplers being attached to said second strap, each of said secondary couplers being positioned adjacent to said second end of said second strap, said secondary strap being wrapped around said support on an associated one of said seats, each of said primary couplers engaging said front surface of said back side adjacent to said second lateral edge of said back side, each of said secondary couplers engaging said back surface of said back side adjacent to said second lateral edge such that said second strap removably couples said container to said associated seat.
